(19) United States
(12) Patent Application Publication
(10) Pub. No.: US 2007/0245506 A1
(43) Pub. Date: Oct. 25, 2007

(54) Variable Function Toothbrushes

(76) Inventor: Paul Michael Clements, Cardiff (GB)

Correspondence Address: KING & SCHICKLI, PLLC, 247 NORTH BROADWAY, LEXINGTON, KY, 40507, US

(21) Appl. No.: 11/568,091

(22) PCT Filed: Apr. 19, 2005
(86) PCT No.: PCT/GB05/01492

§ 371 Date: Oct. 19, 2006

(30) Foreign Application Priority Data
Apr. 19, 2004 (GB) 0408648.4

(51) Int. Cl. A61C 17/32

(52) U.S. Cl. 15/106

(57) ABSTRACT

A hybrid design between manual and electric toothbrush technology with a mechanical rotation or manual brushing action. Brush or polishing units on the toothbrush head are rotated and counter rotated many times when activated by a spring loaded lever but when the lever is locked, the toothbrush allows a conventional manual operation. Permutations of rotary or rectangular brush or polishing units can be used on the same head. The brush units consist of bristle clusters surrounded by a ring of elastomeric nodes suspended over a cavity which moulds to teeth contours. The brush unit design is also shown applied to a manual toothbrush handle. The force applied to the lever allows variable rotation, and when slowly rotating, the bristles on the brush units can search into deep contours of teeth and gum surfaces especially at difficult to reach rear corners of teeth, rather than skipping over them at high speed.

This invention relates to Variable Function Toothbrushes.

The invention proposes a hybrid design between manual and electric toothbrushes, which minimises the inherent design weaknesses found in each type but combines the best features from both types to produce a toothbrush with a manual brushing action, and a mechanical rotation brushing action together with a polishing facility without the need for batteries, motor or a recharger.

The design advantages and disadvantages of existing market place toothbrushes are as follows:

Manual Toothbrushes have a large cleaning surface area and so provide good coverage over teeth. However, this large size makes it difficult to manoeuvre the brush at rear corners of teeth and inhibits an efficient brushing action and co-ordination is not easy in this area. Worn bristles result in the complete disposal of the brush. Teeth cannot be thoroughly polished by manual toothbrushes.

Electric Circular Toothbrushes have a small cleaning surface area, so coverage over all teeth surfaces is slower, but the small head has excellent access to all teeth areas especially at rear corners. Worn brushes are simply replaced with new push-on alternatives. Most operate only at one speed with an oscillating or vibrating motion and they require a motor, batteries or transformer.

The invention proposes a hybrid design taking the best features from both types mentioned above so producing a toothbrush with a manual brushing action, and a mechanical rotation brushing action together with a polishing facility without the need for batteries, motor or transformer. A good surface cleaning area would be provided without compromising access to rear corners of teeth. A second design introduces a manual toothbrush but with the same interchangeable units as the hybrid design.

A toothbrush that is hand activated is shown in GB228978 but this device does not allow for controlled rotation of the brush head. Also, there is no means to lock the brush head, by locking the lever, to allow for manual operation.

The present invention seeks to overcome problems associated with the prior art by providing a variable function toothbrush as set out in claim 1.

The hybrid concept allows utilisation of the features from the toothbrush types mentioned above and uses them in the new design by including drive linkages are hand powered within its body and therefore requires no motor driven power. It facilitates a good surface cleaning area without compromising access to rear corners of teeth and is achieved by deploying two circular cleaning elements on the toothbrush head which has a larger surface area than electric circular brushes, but a smaller surface area than average manual brush heads. To maximise this surface cleaning area, the design proposes a brush element comprising a combination of nylon bristles surrounded by a ring of flat elastomeric nodes. These nodes greatly increase the surface cleaning area and are able to hold more dental paste in contact with teeth, with the advantage of accurately moulding to teeth surfaces, while the nylon bristles have the usual advantage of searching deep teeth contours. Over flexing of bristles is achieved by suspending them in a cradle which is formed with the nodes allowing the entire structure to co-dependently flex which keeps over stressing of bristles to a minimum allowing their ends to have more rigid contact with teeth surfaces even if too much pressure is applied to the toothbrush head. Brush shapes are circular or rectangular and both shapes can be fitted on the toothbrush head at the same time.

They are disposable and polishing elements can be used in their place, with circular cleaning elements being able to rotate and counter rotate fully through 360° in an eccentric or circular path with variable rotation speeds. The speed of the rotating elements varies considerably and is governed by hand movement on a spring loaded lockable lever. When a fast short squeeze action is applied to the lever, the brush elements rotate and counter rotate only partially but quickly allowing thorough cleaning. At very low rotation speeds, cleaning bristles on the brush element can search deep contours such as the area between teeth and gums without skipping across them, so removing difficult food debris and plaque more efficiently especially at rear corners of teeth, while the rectangular brush element allows for larger surface coverage if required with the advantage of it being replaceable. The lever is locked down for use with this type of element, or for circular elements when only manual brushing is desired. A folding toothbrush handle is featured stored within the body of the variable toothbrush, which can hold one rectangular suspension brush elements or one or two circular suspension brush elements with the advantage of replacing them when worn and as a storage brush for a second user with spare brush elements capable of being stored in the foot.

All types of brush cleaning elements are interchangeable, allowing permutations between static and rotating brushes (round and rectangular) on the same head.

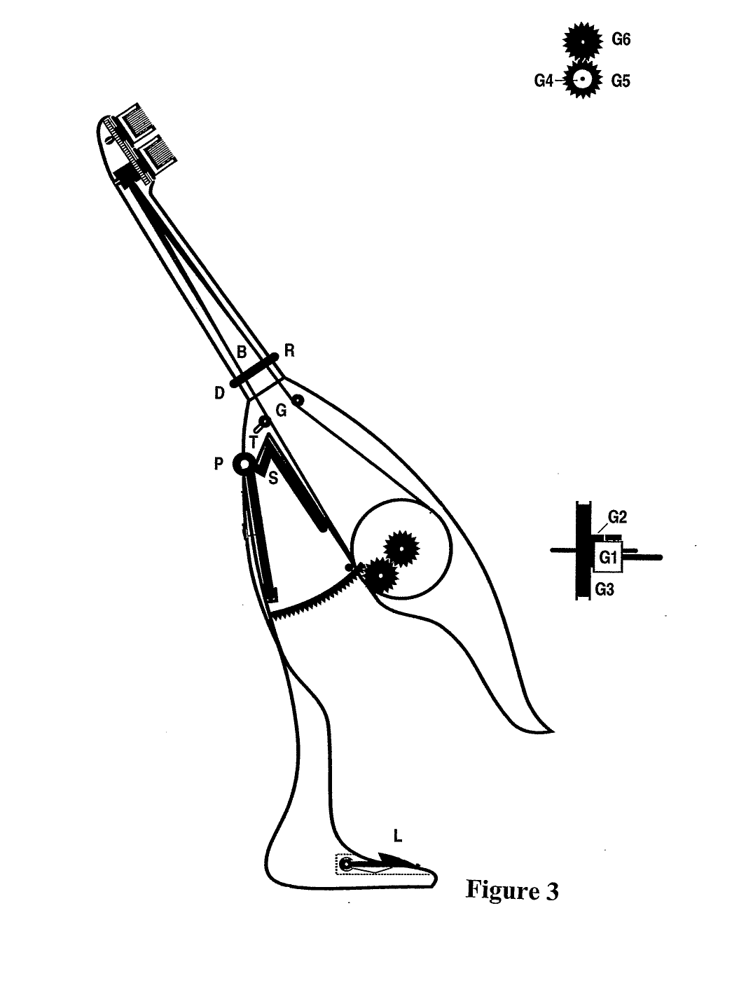

For user choice, typical use of the hybrid concept with two rotating suspension brush elements attached would be to grip the toothbrush from its resting position (FIG. 3) and squeeze the lever allowing is to lock to the body automatically. With dental paste applied a manual brushing action can now commence. The lever can then be instantly unlocked via pressure on a button, allowing a squeeze and release action on the lever which contra-rotates the brush elements so the user can carry out a more thorough mechanical cleaning action especially in difficult to reach mouth areas as described in the earlier paragraph. If required, the brush elements can be unplugged and replaced with two polishing elements with a suitable polishing agent applied to commence thorough mechanical rotational polishing. A single rectangular brush element with a larger surface area could have been used instead of the contra-rotating brush elements if desired.

Renewable attachments feature brush units as mentioned and polishing units which rotate and counter rotate fully through 360° in an eccentric or circular path with variable rotation speeds. The speed of the rotating units varies considerably and is governed by hand movement on a spring loaded lever. When fast short bursts are applied to the lever, the brush units rotate and counter rotate only partially but quickly allowing thorough cleaning. At very low rotation speeds, cleaning bristles on the brush unit can search deep contours especially at the area between teeth and gums without skipping across them, so removing difficult food debris and plaque more efficiently, especially at rear corners of teeth while the rectangular brush unit attachment allows for larger surface coverage with the advantage of it being replaceable. The lever can be locked down for use with this type of unit, or for circular units when only manual brushing is desired.

The Variable Function Toothbrush has many permutations. An embodiment of the invention showing the function and the means to activate a variable function toothbrush will now be described with reference to accompanying drawings by way of example only in which:

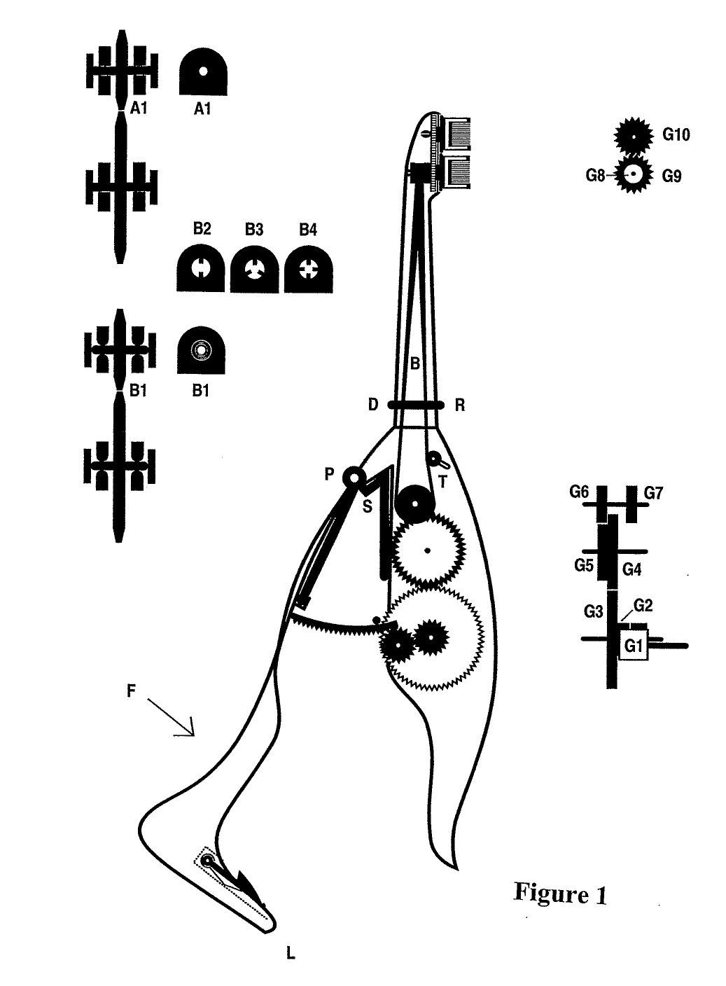

FIG. 1 shows a sectioned front elevation where two belt driven rotating suspension brush units are shown in the un-activated mode and how force F would be applied on the lever to activate them. Different bearing designs are also shown in sectional front and plan view;

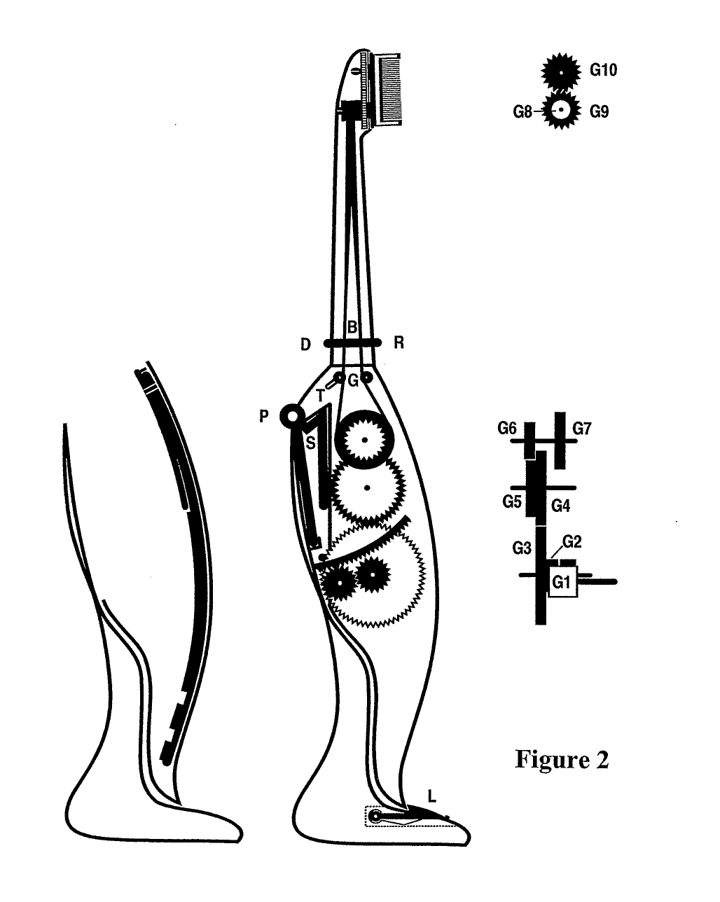

FIG. 2 shows a sectioned front elevation where one rectangular suspension brush unit has been fitted. The lever has been depressed and appears in the locked down position when a conventional brushing action is required. Also shown is the storage position of a folding handle which can accommodate suspended brush units. A slightly different gearing configuration is also shown;

FIG. 3 shows a sectioned front elevation where two belt driven rotating suspension brush units are shown in the un-activated mode an with the toothbrush in its draining position and features less gearing in the body;

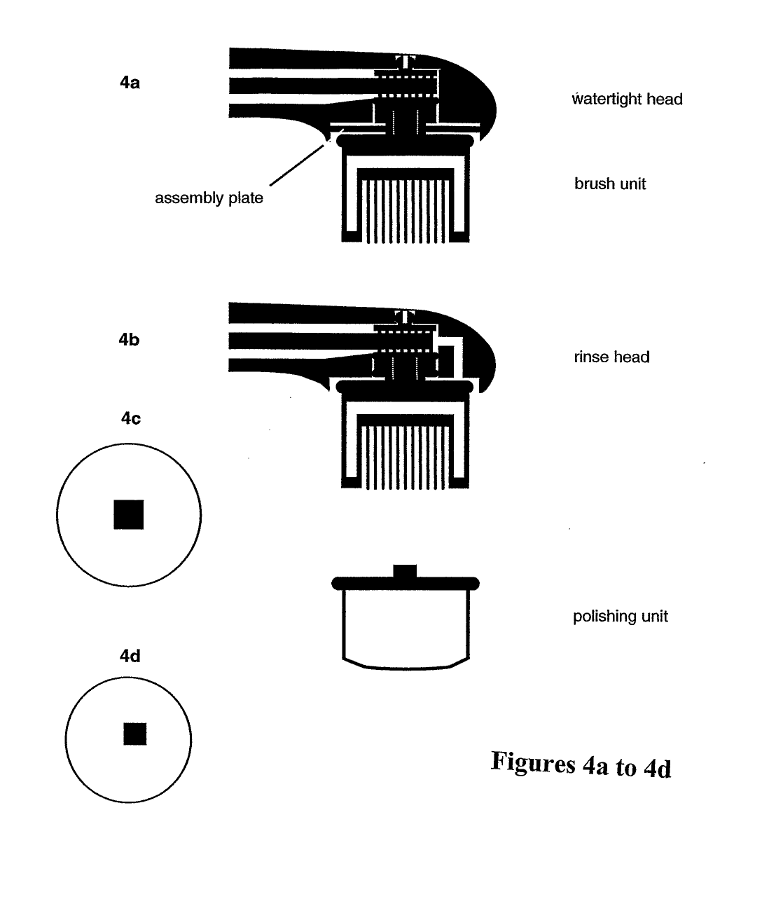

FIG. 4 shows sectional head details of single rotating suspension brush unit and a polishing unit with and without a watertight plate. A rinse duct is also illustrated as well as plan views of different pad axles;

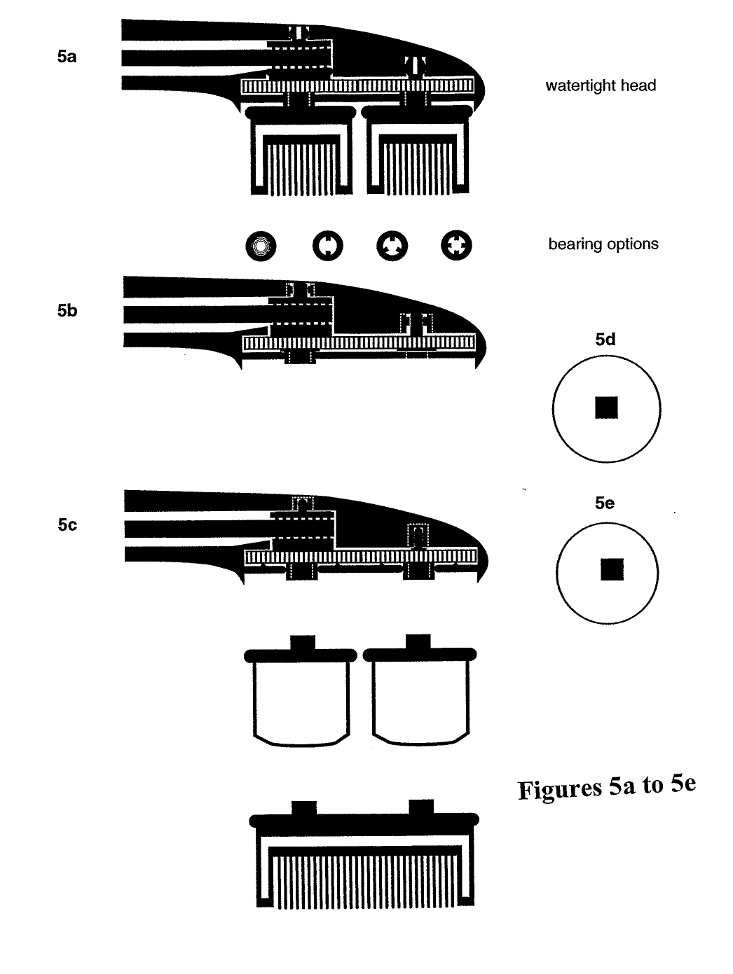

FIG. 5 shows sectional head details of two rotating suspension brush units and polishing units of the same diameter with a single suspension rectangular brush for use when the lever is in the lock down mode. Six different bearing/axle options are also shown in sectional front and plan view together with plan views of different pad axles;

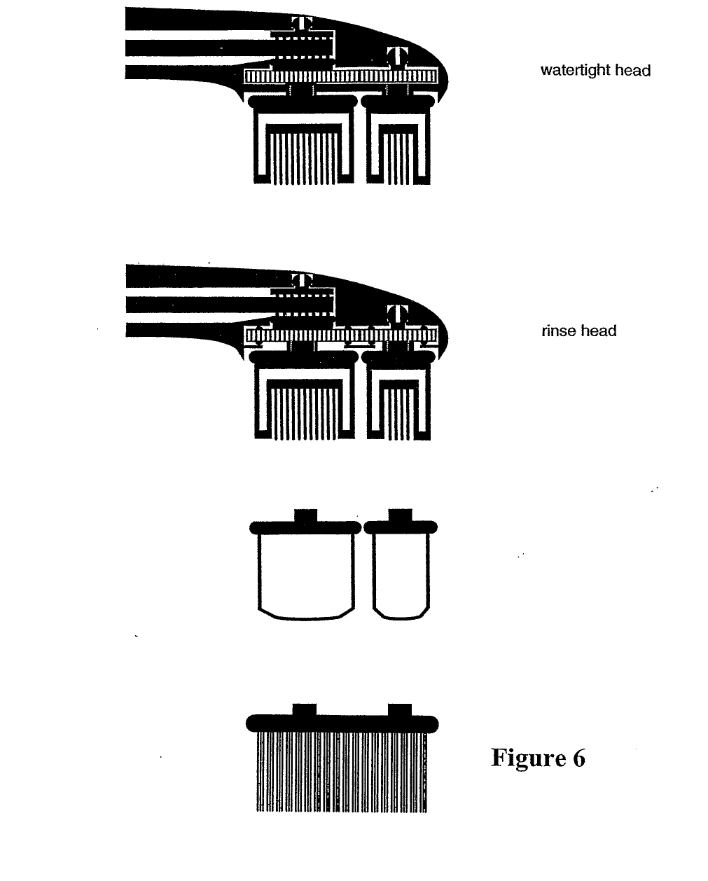

FIG. 6 shows sectional head details of two rotating suspension brush units and polishing units and a polishing unit of different diameters with a single conventional rectangular brush for use when the lever is in the lock down mode. Different assembly plates are also illustrated allowing for rinsing of the head or a watertight head;

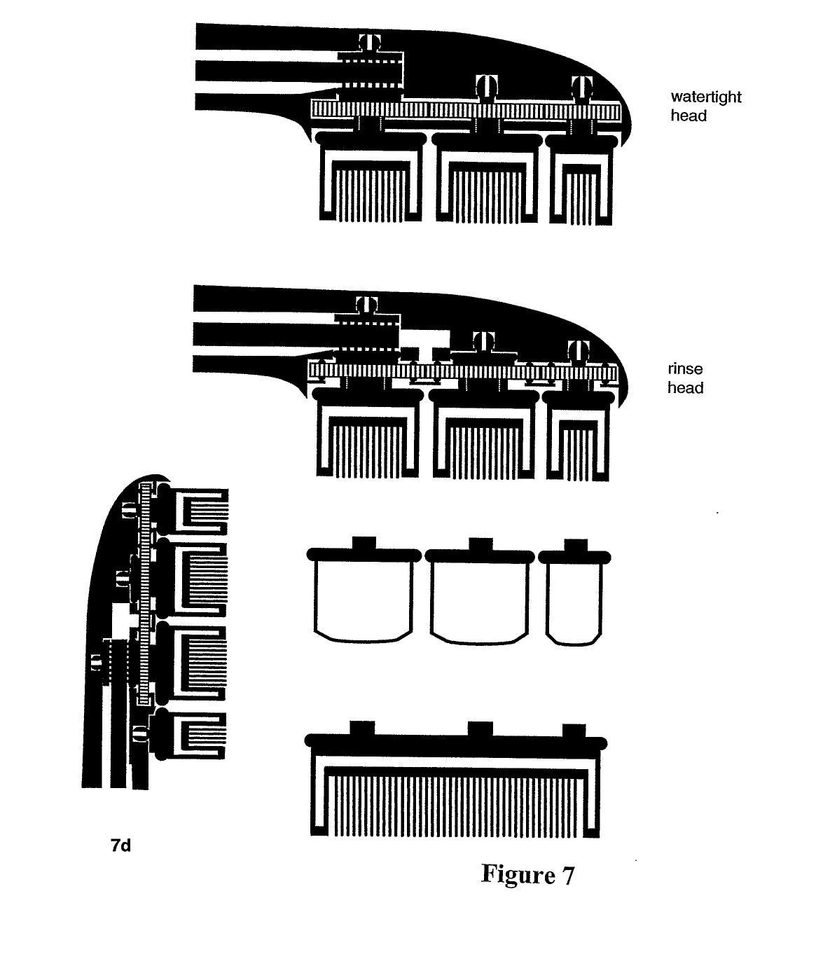

FIG. 7 shows sectional head details of three rotating suspension brush units of different diameters and a four head configuration with one unit being static. A single suspension rectangular brush unit is shown for use when the lever is in the lock down mode. Different assembly plates are illustrated. A rinse duct is also shown;

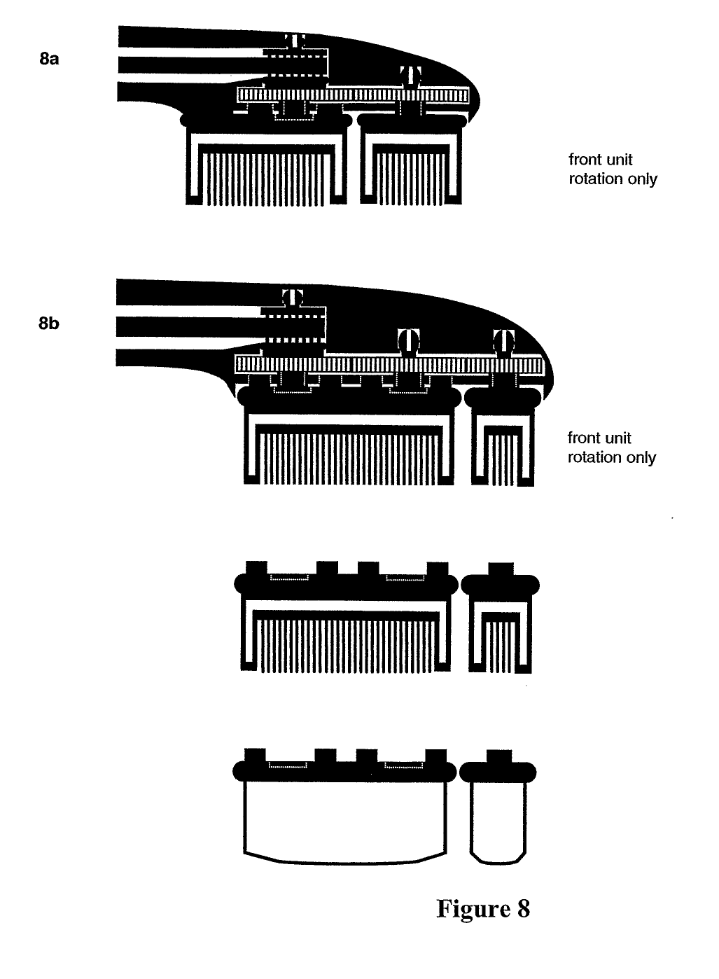

FIG. 8 shows sectional head details of one rotating suspension brush unit and one static rectangular brush unit, but featured on different size toothbrush heads 8a and 8b. Also shown is the same polishing configuration;

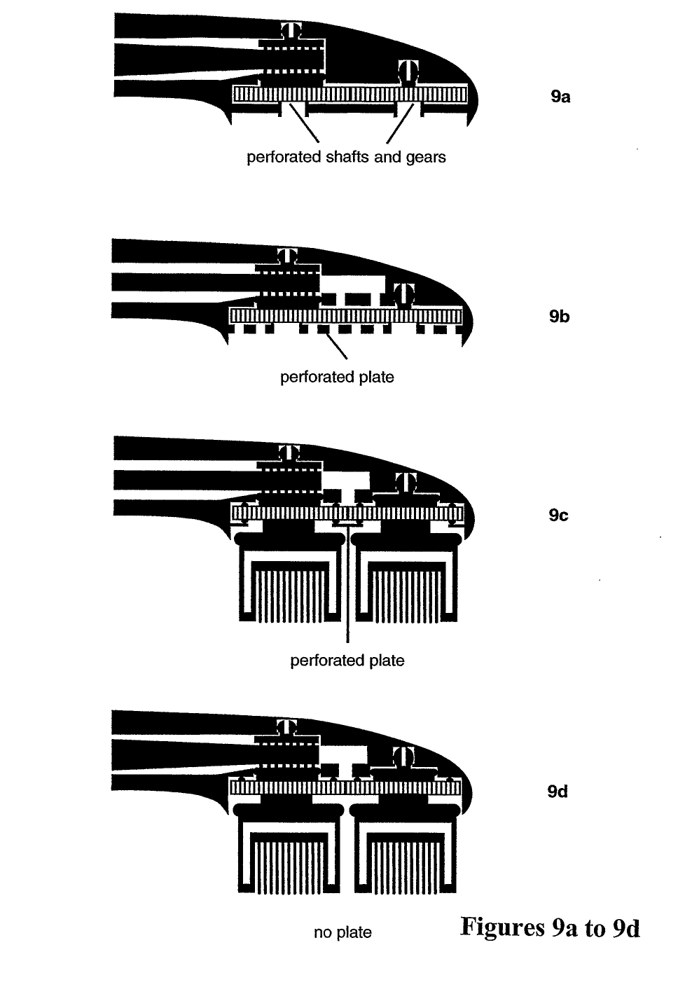

FIG. 9 shows sectional head details with assembly plate and different types of rinse access, with or without rinse plates. Different types of rinse ducting are illustrated;

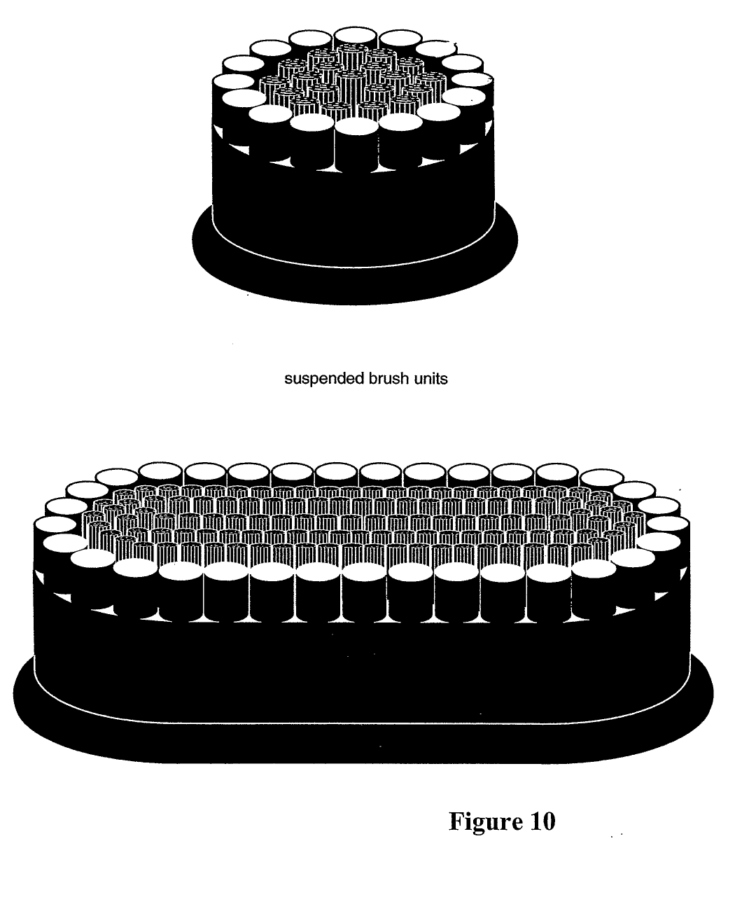

FIG. 10 shows an isometric diagram of a rotational suspension brush unit and a rectangular suspension brush unit;

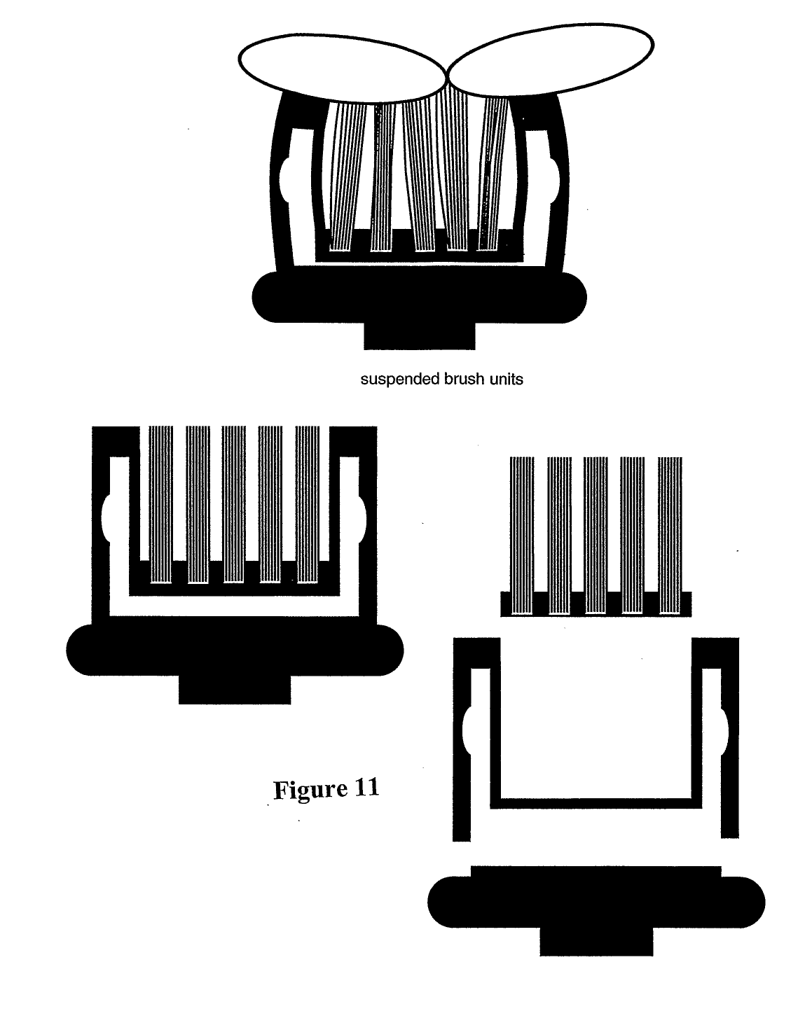

FIG. 11 shows sectional diagrams of rotating suspension brush units;

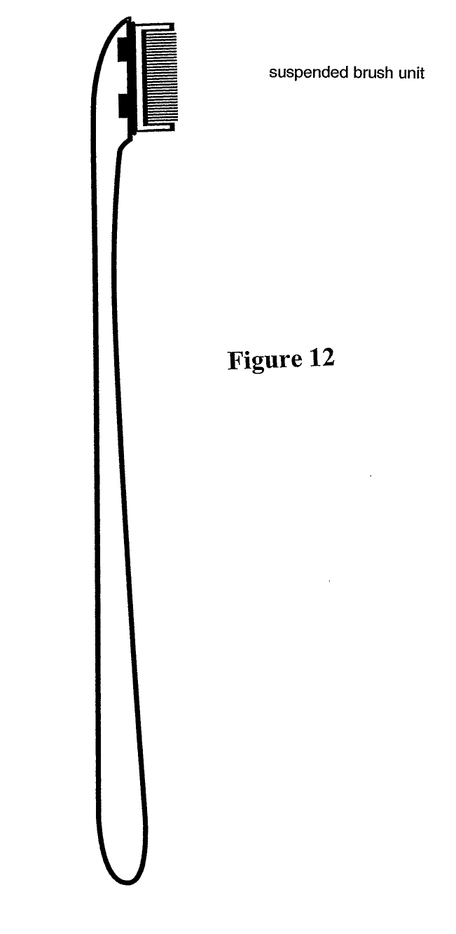

FIG. 12 shows a manual toothbrush which is able to accommodate one rectangular suspension brush unit or one or two rotating suspension brush units.

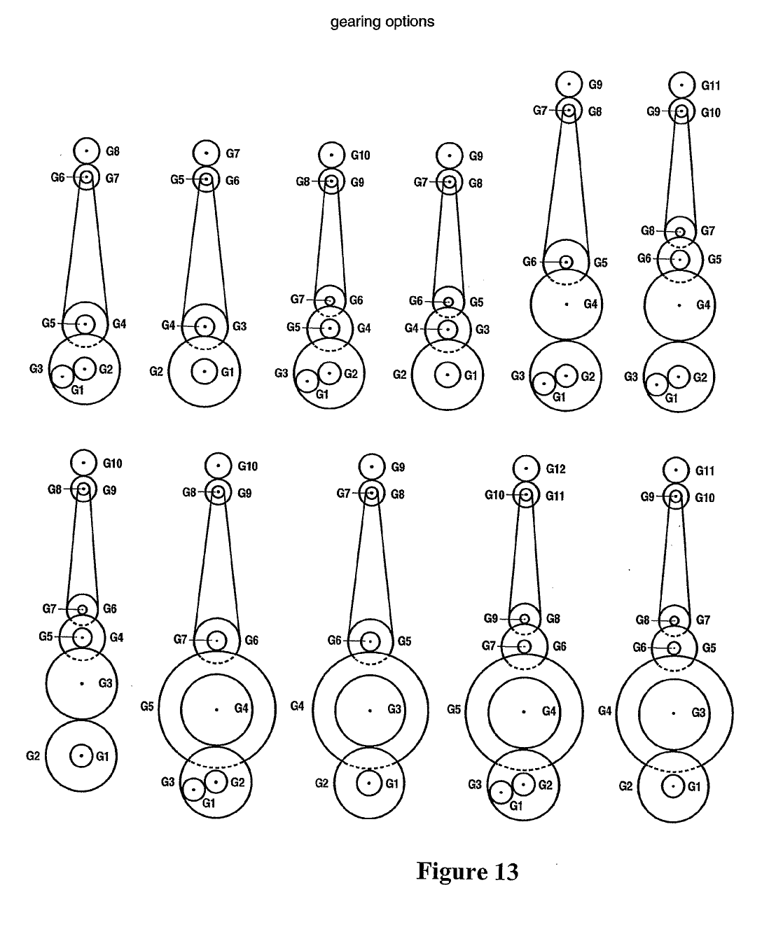

FIG. 13 shows optional gearing configurations.

Referring to all drawings but initially to FIG. 1, the hand operated toothbrush is shown with toothed drive belt and two brush units in the un-activated mode. It can be divided into the body neck and head, and is activated and utilised in the following way;

In FIG. 1 the body shows gearing activated by a force F on a lever with a spring S at its pivot P. When the lever is activated, a toothed drive belt B linking gearing in the body and head rotates the brush units several times through 360°. The brush units rotate in different directions, cancelling out any skating rotation. When the force is released from the lever, the pent-up energy in the spring returns the lever to its original position and in doing so, counter rotates the brush units, belt and gearing in the body.

The gearing shown in FIG. 1 allows the brush units to rotate and counter rotate many times with each depression and return of the lever.

Conventional brushing can be achieved with either circular or rectangular units by locking down the lever with a device shown in FIG. 2 which automatically locks the lever when squeezed, and is released by depressing a spring loaded button. The lever has on its underside a gear arm set in an arc, and is in contact with gear G1 which has its own axle and is in contact with G2 joined on the same axle with gear G3. Gears G4 and G5 share the same axle with G4 in contact with G3. Gears G6 and G7 also share the same axle and are spaced either side of G4 while G5 is in contact with G6. The toothed drive belt links gear G7 in the body to gear G8 in the head and can be adjusted for tension at T which is optional. Because these two gears are on different planes, the drive belt linking them is shown rotated through 90°, but on rotation of the neck at R, the belt becomes parallel when turned through 180°. This neck rotation allows user friendly adjustment, however, it does not have to rotate and can be cast with the body and head in one piece. A drip ring D is shown near R. Gears G8 and G9 in the head are set on the same axle while G10 has its own axle.

FIG. 2 shows a larger body gear G7 which allows more rotation on the head gears G8 to G10 and FIG. 3 illustrates a completely different body gear configuration using less components but giving a similar rotation performance to the gears in FIG. 1. Two freely rotating guide bosses G keep the drive belt in its correct alignment while travelling through the neck and are shown on both FIGS. 2 and 3. The bosses can adjust for belt tension if necessary as illustrated T of FIGS. 1, 2 and 3 which is optional. All axles on gears in the body and head locate into bearing holes of optional designs and are illustrated in A1 and B1-B4 of FIG. 1 and FIGS. 5a, 5b and 5c.

Bearings B1-B4 are designed for reduced friction on the axles. The ends of all axles can be rounded which again reduces friction when in contact with a surface. FIGS. 5a, 5b and 5c show different types of axles on head gears G9 and G10 together with different assembly plates while 5b shows bearings options as mentioned in FIG. 1. FIGS. 4c and 4d, and 5d and 5e in plan view show 2 types of brush unit axles; 4c and 5d illustrates the axles placed centrally while 4d and 5e shows the axles offset allowing the brush unit to rotate in an eccentric path to cover a larger cleaning area.

The contact surfaces of all gears can be narrowly bevelled or rounded to reduce friction (see A1 and B1 in FIG. 1) which shows this as a sectional horizontal plan view and only represents the principle. All brush units and polishing units have square axles projecting from their upper surfaces which push up into corresponding location holes situated in G9 and G10, allowing surfaces to mate together to a flush watertight fit. Once worn, the units can simply be un-plugged and discarded. Units can be used in various configurations with different size toothbrush heads; single, double, odd double, or triple.

FIG. 6 shows sectional head details of two rotating suspension brush units and polishing units and a polishing unit of different diameters with a single conventional rectangular brush for use when the lever is in the lock down mode. Different assembly plates are also illustrated allowing for rinsing of the head or a watertight head;

FIG. 7 shows sectional head details of three rotating suspension brush units of different diameters and a four head configuration with one unit being static. A single suspension rectangular brush unit is shown for use when the lever is in the lock down mode. Different assembly plates are illustrated. A rinse duct is also shown;

FIG. 7d shows a head with four units—three rotating and one static.

FIG. 8 shows sectional head details of one rotating suspension brush unit and one static rectangular brush unit, and these can be featured on different size toothbrush heads 8a and 8b. The same configuration can be used for the polishing configuration;

FIG. 9 shows sectional head details with assembly plate and different types of rinse access, with or without rinse plates. Different types of rinse ducting are illustrated;

FIGS. 10 and 11 show isometric diagrams of circular and rectangular suspended brush units.

FIG. 11 shows sectional diagrams of rotating suspension brush units;

FIG. 12 illustrates how a rectangular suspension unit can be applied to a conventional toothbrush handle. The handle can also accommodate one or two units which are shown in this case as circular units.

Flush fittings of the units and an assembly plate shown just above the units are a means of keeping the head watertight. However, if periodic rinsing of gears and inner surfaces of the head is found to be necessary, this can be achieved in several proposed ways—see FIG. 9. The ends of the shafts that the pad axles plug into are perforated (see FIG. 9a) allowing flushing to inner head surfaces once the units have been removed. Water can be applied down the neck through a hole located near the drip ring or by holding the head under running water while activating the lever several times. Alternatively, a plate installed to hold the gearshafts in place can be perforated (see FIGS. 9b and 9c) or removed altogether (see FIG. 9d) allowing easy rinsing to all internal head areas. Gears can also be perforated. FIGS. 9c and 9d show how it would be necessary to stabilise perforated gears G9 and G10 during rotation with several nodes on their horizontal surfaces. Another method of stabilising the head gears is shown in 5b where a ring is located around the shaft just before it runs through the assembly plate. This also applies to the single gear shown in FIG. 4b with the plate removed and has two stabilising rings around its shaft.

Although not fully illustrated in FIGS. 4-7, this rinsing design concept shown as FIGS. 9a 9b 9c 9d applies to toothbrush heads containing single, double, odd double, and triple rotating units. It also applies to the quadruple pad configuration.

A drive shaft can be used instead of the belt drive mentioned above. The advantage being that the neck can be slightly tapered allowing a different head angle in relation to the grip position of the body. The proposed drive shaft would have a bevelled gear at each end, one mating with G7 itself a bevelled gear and still sharing the same relationship with other gears as mentioned in the paragraph above. The bevelled gear at the other end of the drive shaft would mate with G8, this also being a bevelled gear but again sharing the same relationship with other gears in the head as described in the paragraph above. The drive shaft would be secured by running through bearings near each bevelled gear.

The invention covers not only individual embodiments as described but also combinations of all embodiments discussed.

1. A variable function toothbrush, comprising a handle and a head, the handle containing a geared linkage which can be caused to rotate by way of pressure on a lever associated with the handle, to cause rotation and counter rotation of one or more brush elements mounted on the head of the toothbrush, characterised in that the lever is lockable to the handle to allow for manual brushing of the teeth and the lever is also unlock able from the handle to allow for activation of the lever to cause rotation and counter rotation of the one or more brush elements to allow for mechanical brushing of the teeth by way of the moving head or heads.

2. A variable function toothbrush according to claim 1, wherein the one or more elements comprise one or more bristle clusters bordered by a ring of elastomer nodes.

3. A variable function toothbrush according to claim 2, wherein the bristle clusters are supported on a non-flexing cradle.

4. A variable function toothbrush according to claim 1, wherein the lever is a lockable pivotal lever, the position of which determines the mode of operation of the toothbrush.

5. A variable function toothbrush according to claim 1 whose manual brushing action is determined by the lever being push locked to the body ensuring selected brush elements fitted remain static, and whose rotary brushing action is determined by the lever being unlocked allowing linkages to be activated and drive a pair of contra-rotating brush elements which turn at speeds controlled by the lever.

6. A variable function toothbrush according to claim 5, further including plug in cleaning elements comprising three types selected from paired contra-rotating brush elements, paired contra-rotating polishing elements, and a single static brush element all of which can be mounted to the head and further including a combination of a single rotating brush element and a smaller static brush element also mountable to the head, the paired cleaning elements being able to contra-rotate through about 360°.

7. A variable function toothbrush according to claim 1, whose brush elements comprise bristle clusters with a rigid base supported in a cradle which forms a surround of elastomeric nodes having flat top surfaces for teeth contact.

8. A variable function toothbrush according to claim 7, whose elastomeric nodes and suspension cradle form a single structure from the same material and allows a seating of bristles moulded to a rigid base to fit into the cradle so that the structure can co-dependently flex when responding to a range of pressure from the moulding contact action to teeth contours, so avoiding over flexing of the bristles even if too much pressure is exerted on the toothbrush head by the user which allows the bristle scraping ends to stay in contact with teeth surfaces.

9. A variable function toothbrush according to claim 1 having at least two types of plug in cleaning elements fitted to the same size toothbrush head in the form of round contra-rotational or non-rotatable brush elements, comprising brush elements in the form of bristle clusters set into a solid rigid base.

10. A variable function toothbrush according to claim 1 having paired polishing elements formed from an elastomeric material and which can controllably contra-rotate through about 360° at variable polishing speeds controlled by the lever.

11. A variable function toothbrush according to claim 1 wherein the gearing contained in the handle allows the or each brush element to rotate.

12. A variable function toothbrush according to claim 1 wherein the handle is foldable and stored therein is the or each brush element.

13. A variable function toothbrush according to claim 12 wherein the head accommodates rotating and/or contra-rotating brush elements.

14. A variable function toothbrush according to claim 1 where the head additionally accommodates a static brush element.

15. (canceled)

16. A variable function toothbrush according to claim 1 wherein the head accommodates two or more of a rotating brush element and/or two or more pairs of contra-rotating brush elements, and/or a single non-rotating brush element.

17. A variable function toothbrush according to claim 1, wherein the rotating brush elements are at least two elements and are of different sizes.

18. (canceled)

19. A variable function toothbrush according to claim 1 wherein the head is fittable to a conventional toothbrush handle.

20. A variable function toothbrush according to claim 1 wherein the brush elements rotate about an eccentric path when rotated.

21. A variable function toothbrush according to claim 1 adapted to have conventionally manufactured brush elements fitted.

22. (canceled)

23. A variable function toothbrush according to claim 1 wherein the gearing includes a drive belt.

24.-37. (canceled)
